(19) United States
(12) Patent Application Publication
(10) Pub. No.: US 2004/0220824 A1
(43) Pub. Date: Nov. 4, 2004

(54) Method and apparatus for providing services in recycling products

(76) Inventors: Hiroaki Imai, Yamato (JP); Takeshi Suzuki, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/736,631

(22) Filed: Dec. 17, 2003

(30) Foreign Application Priority Data
Jun. 17, 2002 (JP) 2002-175530

(51) Int. Cl. G06F 17/60

(52) U.S. Cl. 705/1

(57) ABSTRACT

A computer checks the number of repeated uses of a product such as a commodity vessel and a commodity by a user and a service corresponding to the number of repeated uses is provided to the user. When a user brings a product, the reader/writer section of the computer reads storage information on the product from the writable storage medium attached to the product. From the storage information which has been read, the number of repeated uses of the product is calculated. The computer references a table containing the numbers of repeated uses of the product and service contents corresponding to the numbers and decides the service content corresponding to the calculated number of repeated uses. The service content decided is provided to the user. As the writable storage medium, it is possible to use a non-contact IC chip.

### BACKGROUND OF THE INVENTION

The present invention relates to a method for providing appropriate services by a computer to a user of repeated use of a product such as a commodity vessel or a commodity.

As the economics develop, so-called “mass production and mass consumption” generate a large amount of waste. The waste is a large factor to compress the life environment. Reduction of amount and volume of waste are sought. What is necessary is to re-use a used product. At present, in Japan, so-called “Electric Appliance Recycling Law” has come into force and the cyclic society system has started in this field.

On the other hand, there is a member service providing system that a point based on the consumption sum is given to a consumer when the consumer purchases a commodity so that a settlement sum at the next purchase is reduced or another commodity is provided. The consumer carries a card or the like on which the point is recorded and shows the card when purchasing a commodity to receive a point at the checkout counter.

There are various recycling methods such as the Electric Appliance Recycling Law considered to realize a recycling society or a conventional waste collection. However, these methods have a concept that unnecessary commodities are collected and collection fee should be paid according to the recycling cost, which is not well-received by consumers. Moreover, the object to be recycled is limited to a particular commodity. For example, products which are not so expensive and easily consumed as daily products (including their vessels and wrapping) have not been included in consideration of recycling.

As has been described above, there is a case that a consumer intending recycling is charged and there is almost no case that a service is provided according to recycling. The only exception is that a consumer giving a used product to a recycling agency receives some money or goods once. That is, there has not been a method for management of history of repeated use of a product and providing a service to the user of the product according to the repeated use.

There has not been suggested a method or a system for giving a point according to a recycling frequency to the aforementioned card recording the point and it has been difficult to rapidly provide services to a consumer according to recycling at sales site indoor or outdoor, at a fixed place or a mobile place.

### SUMMARY OF THE INVENTION

It is therefore an object of the present invention to easily promote repeated use of a product and provide a service according to it.

In order to achieve the aforementioned object, the method for providing services in recycling products according to the present invention is a method for providing appropriate services by a computer to a user of a repeated use of a product such as a commodity vessel or a commodity. The method includes: a step that the computer receives from a reader/writer section which has performed reading from the readable/writable storage medium (hereinafter, simply referred to as “writable storage medium”) attached to the product presented by the product user, the storage information of the writable storage medium acquired by the reading operation, a step of recognizing the use history of the product from the storage information acquired, a step of judging the service content by checking the use history recognized in a table where service content is defined according to the number of repeated uses of the product, and a step of executing a processing according to the service content judged and outputting the processing result to an output apparatus.

According to an embodiment of the present invention, products to be recycled are not limited to particular products and it is possible to promote recycling (repeated use) of products easily consumed as daily commodities (including their vessels and wrapping). Moreover, since there is almost no case to cause a cost load on a consumer who is trying to perform repeated use of a product, recycling is further promoted.

Furthermore, a history of repeated use of a product is easily managed and it is possible to provide a service to a user according to the repeated use state.

Additionally, it is possible to rapidly provide a service according to the recycle to a consumer in a sales site indoor or outdoor, at a fixed place or a mobile place.

According to the present invention, it is possible to facilitate promotion of repeated use of a product and providing services according to it.

Other objects disclosed by the present application and the method to achieve the objects will be made clear by the embodiments of the invention and the drawings.

### BRIEF DESCRIPTION OF THE DRAWINGS

FIG. 1 shows an outline of a service providing method according to a present embodiment.

FIG. 2 shows a system configuration including a service providing apparatus according to the present embodiment.

FIG. 3 shows a flow of the service providing method according to the present embodiment.

FIG. 4 shows an example of data structure recorded in a writable storage medium according to the present embodiment.

FIG. 5 shows an example of data structure of a table defining the service contents according to the repeated number of uses of a product.

According to the description of the present Specification, at least the following will be made clear.

The method for providing services in recycling products may further comprise a step of instructing the reader/writer section to write a use history in the writable storage medium according to a commodity or a service when the presentation of the product by the product user is upon a commodity or service purchase accompanied by the repeated use of the product.

Moreover, the method for providing services in recycling products may further comprise: a step of attaching a writable storage medium to the product presented upon purchase of the commodity or service if the product has no writable storage medium, and a step of instructing the reader/writer section to write the use history to the attached writable storage medium according to the commodity or service purchase content.

The method for providing services in recycling products may further comprise: a step of providing a product having a writable storage medium if no product is presented by the product user upon purchase of the commodity or service, and a step of instructing the reader/writer section to write the use history into the writable storage medium attached to the provided product according to the commodity or service purchase content.

Furthermore, there is provided a computer for providing appropriate services to a user of a repeated use of a product such as a commodity vessel or a commodity, the computer comprising: means for receiving from a reader/writer section which has performed reading from a writable storage medium attached to the product presented by the product user, the storage information of the writable storage medium acquired by the reading operation; means for recognizing the use history of the product from the storage information acquired; means for judging the service content by checking the use history recognized in a table where service content is defined according to the number of repeated uses of the product; and means for executing a processing according to the service content judged and outputting the processing result to an appropriate output apparatus.

Furthermore, there is provided a program for causing a computer to execute a method for providing appropriate services to a user of a repeated use of a product such as a commodity vessel or a commodity, the program comprising: a step of receiving from a reader/writer section which has performed reading from a writable storage medium attached to the product presented by the product user, the storage information of the writable storage medium acquired by the reading operation, a step of recognizing the use history of the product from the storage information acquired, a step of judging the service content by checking the use history recognized in a table where service content is defined according to the number of repeated uses of the product, and a step of executing a processing according to the service content judged and outputting the processing result to an appropriate output apparatus.

Moreover, there is provided a computer readable recording medium containing the aforementioned service providing program.

### DESCRIPTION OF THE EMBODIMENTS

Description will now be directed to embodiments of the present invention with reference to the attached drawings.

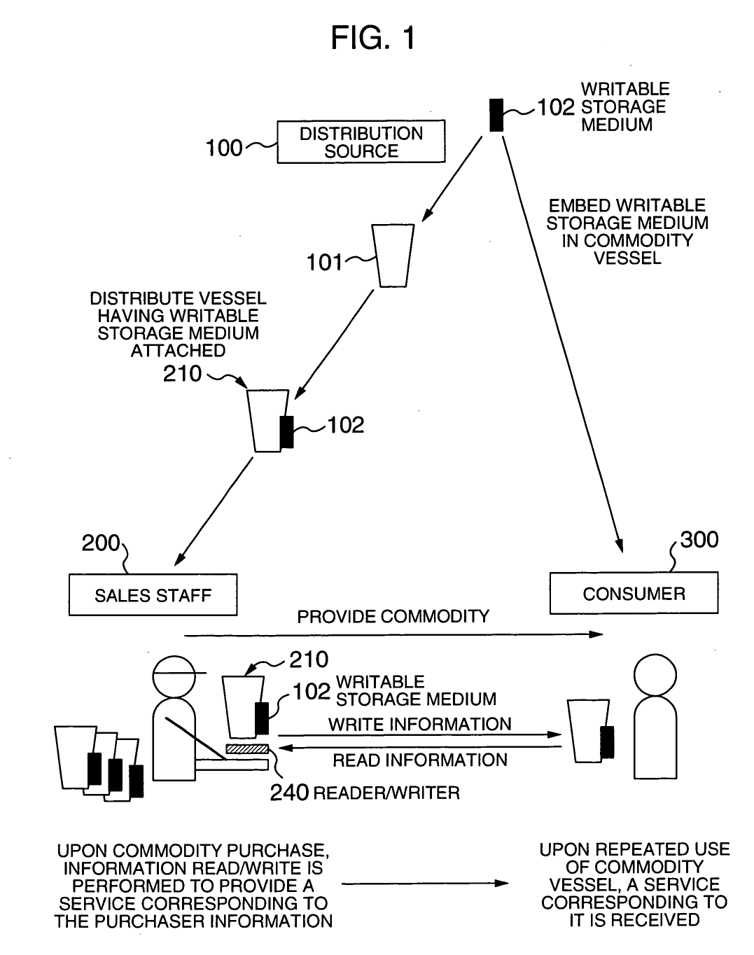

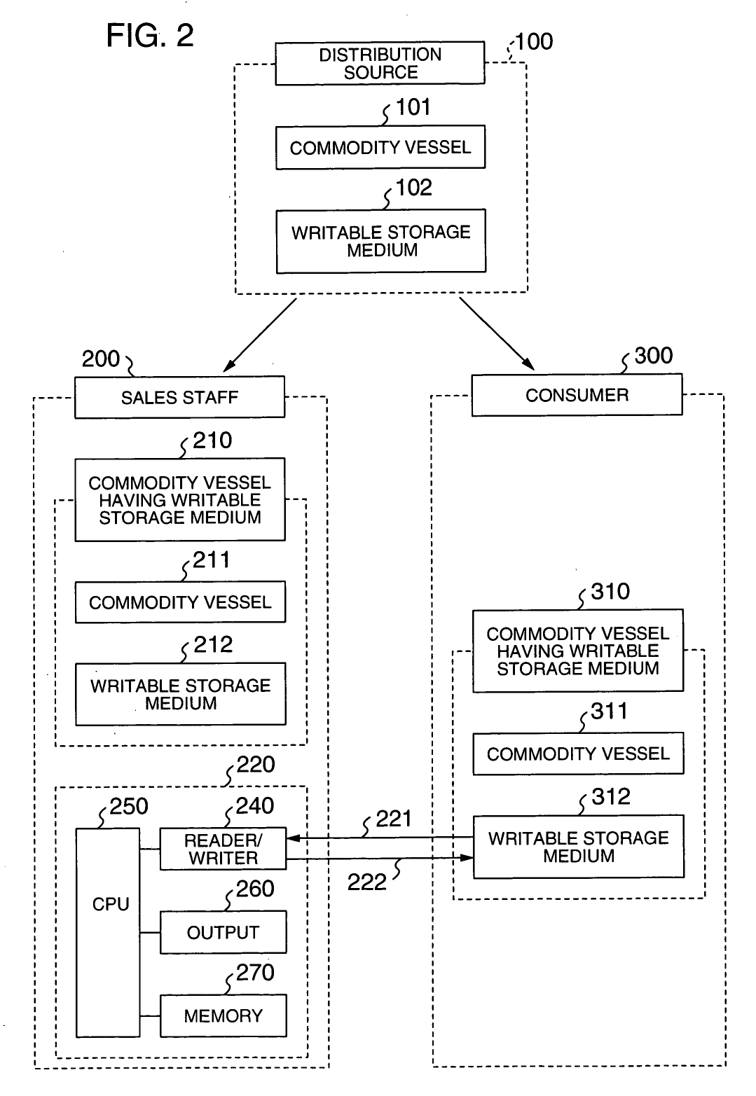

FIG. 1 shows an outline of service providing method according to a present embodiment. FIG. 2 shows a system configuration including a service providing apparatus according to the present embodiment. This embodiment assumes that a beverage company 100 (distribution source in the drawing) distributes beverage contained in a commodity vessel 101 to stores and in each of the stores, a sales staff 200 face-to-face sells the beverage to a consumer 300. In this case, a writable storage medium 102 such as a non-contact IC chip (hereinafter, referred to as a non-contact IC chip) is attached to the commodity vessel 101 of the commodity sold and according to the information obtained by writing/reading onto/from this non-contact IC chip 102, the service providing method of the present invention is provided.

The present invention is not to be limited to the present embodiment and can be applied to any situation for repeated use of a commodity which can be used repeatedly. It should be noted that in this embodiment, explanation has been given on the case that the object to which the writable storage medium 102 is attached is the commodity vessel 101. However, it is also possible that the writable storage medium 102 is attached to the commodity contained in this commodity vessel 101 or a “product” including the commodity vessel 101 and the commodity. Moreover, a consumer 300 is assumed to be a “product user” who repeatedly use the “product” such as a commodity vessel and a commodity.

In this embodiment, if the commodity vessel 101 is made of a paper sheet having an appropriate thickness, the non-contact IC chip 102 as the writable storage medium is embedded in this material of the commodity vessel 101, i.e., filled in the thickness of the commodity vessel 101. Alternately, it is possible to attach the non-contact IC chip to the commodity vessel 101 by using a seal material. Anyway, what is necessary is to add the writable storage medium 102 to the commodity vessel 101, or the commodity, or the product including both of them.

Moreover, as the writable storage medium 102, there can be exemplified an RFID (Radio Frequency IDentification) as has been described above. This non-contact IC chip 102 is, for example, issued and managed by the beverage sales company 100 by setting the ID (hereinafter, referred to as chip ID). Although not depicted, it is also possible that an ID management center (authority issuing and authenticating the chip ID) as a third organization issues and manages the attachment seal material prepared by embedding the non-contact IC chip 102 or the commodity vessel 101 itself.

Here, the non-contact IC chip 102 is a so-called RFID chip which has an internal antenna. Through this antenna, power supply and data read are enabled from a reader/writer and the like. The RFID chip includes a CPU, an RAM, an ROM, an EEPROM, and the like. The chip ID is recorded on the non-volatile read only ROM or the non-volatile electrically writable and erasable EEPROM. The chip ID is a unique number assigned for each non-contact IC chip. For example, it is possible to apply an assigning rule for each type of the commodity and commodity vessel or the attribute of the sales store like the JAN code (Japanese Article Number code).

The beverage sales company 100 preferably registers the chip ID of a non-contact IC chip 102 on an appropriate management server (not depicted) before supplying the commodity vessel 101 to which the non-contact IC chip 102 is attached to the sales staff 200 of the sales store. Thus, it is possible to acquire and grasp the recycling state of the commodity vessel 101 of the consumer 300 for each of the commodity vessels 101 from the computer having the reader/writer section for realizing the present invention or to acquire information by correlating the recycling state to the attribute of the consumer 300, thereby improving the customer service and increasing the demand prediction accuracy.

The sales staff 200 uses the reader/writer device 220 as a computer realizing the service providing method of the present invention. This reader/writer device 220 mainly consists of two functions: a reader/writer section 240 and a computer section 250 and further includes a display and a thermal printer as an output section 260 as well as a memory section 270. The reader/writer section 240 reads the non-contact IC chip 102 mounted on the commodity vessel 210 having the writable storage medium (the non-contact IC chip 102 is attached to the commodity vessel 101) and transmits the obtained storage information to the computer section 250.

The computer section 250 recognizes the storage information and writes/reads the use history according to the situation or judges the service to be provided according to the use history. For this, a table defining the service contents according to the number of the repeated uses of the commodity vessel 210 having the writable storage medium (hereinafter, referred to as a vessel 210 having a chip) is stored in the memory section 270.

Additionally, when the computer 250 performs write to the non-contact IC chip 102, a digital signature inherent to the reader/writer device 220 is executed, thereby improving the security performance. This digital signature may be inherent to device owned by the beverage company 100 instead of the reader/writer device 220. When such a digital signature is executed upon writing processing, it is possible to find and suppress false alteration of data by an unauthorized person.

Furthermore, if the chip ID issue of the non-contact IC chip 102 is also to be performed by this reader/writer device 220, the non-contact IC chip containing the chip ID is issued and attached to the commodity vessel 101 so as to constitute a vessel 210 having the chip. For example, the reader/writer device 220 is provided with a mechanism for embedding or attaching the non-contact IC chip 102 to the commodity vessel 101. By having this function, it is possible to cope with a situation when a commodity vessel 311 represented by a consumer 300 has no writable storage medium 312. Moreover, since the reader/writer device performs the function of the chip ID issuance/authentication station, it can also judge whether any falseness is present in the recording information of the non-contact IC chip 312 of the vessel 310 having the chip represented by the consumer 300.

On the other hand, the consumer 300 brings to the store the vessel 310 having the chip which has been bought before and whose content has been consumed (or only the commodity vessel 311 if no non-contact IC chip is present) and offers its repeated use. That is, beverage to be purchased is again poured into the vessel 310 having the chip which has been used before. In this case, the reader/writer device 220 records the number of the repeated uses on the non-contact IC chip 312 attached to the chip-equipped vessel 310, judges a service according to the content, and provides the corresponding service to the consumer 300 (or notifies the method to receive the service). The consumer 300 does not need any device or system to receive the serve.

It should be noted that the reader/writer section 240, the computer section 250, and the output section 260 in the reader/writer device may be constituted as a unitary handy terminal. Moreover, as another example, the reader/writer section 240, the computer section 250, and the output section 260 may be connected via a network.

Moreover, the reader/writer device 220 is not limited to the handy terminal type device. For example, it may be any device having a computer chip which can be connected to a network such as a mobile telephone connectable to a network, a kiosk terminal, a PDA, a game device, a digital TV, and a facsimile and has a reader/writer function of the non-contact IC chip 102 as the writable storage medium.

Furthermore, the commodity vessel 311 presented by the consumer 300 to the sales staff 200 is not limited to the commodity vessels 101, 211 provided by the distribution source beverage company 100 and the sales staff 200 or to the chip-equipped vessel 210 but may be any commodity vessel brought by the consumer 300.

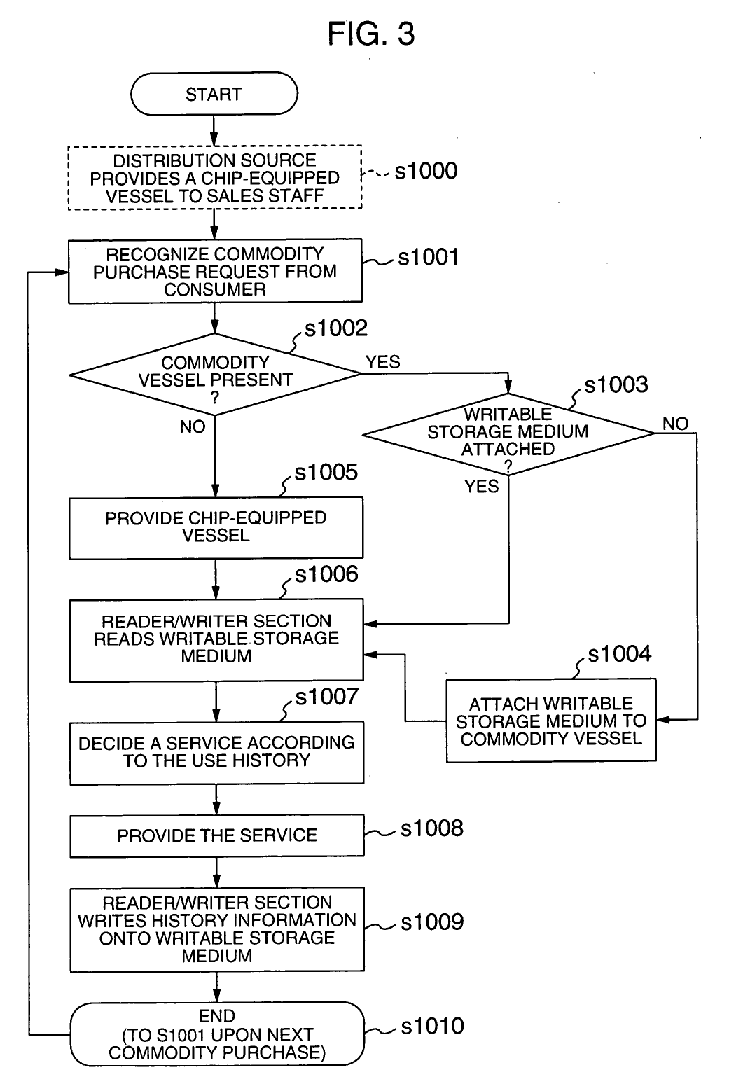

FIG. 3 shows a flow indicating an actual procedure of the service providing method according to the present embodiment. Hereinafter, the actual procedure of the service providing method of the present invention will be explained in accordance with the processing procedure of the reader/writer device 220. It is assumed that the consumer 300 who wants to buy the beverage provided by the beverage sales company 100 brings to the sales store a chip-equipped vessel 310 acquired when he/she bought the beverage before, so that the beverage to be bought is poured into the chip-equipped vessel 310. As has been described above, there is also a case that the commodity vessel 311 brought by the consumer 300 has no non-contact IC chip or the consumer does not bring a commodity vessel.

Prior to this processing procedure under such a situation, the beverage sales company 100 provides a chip-equipped vessel 210 to the sales staff 200. Alternatively, the commodity vessel 211 and the non-contact IC chip 212 are separately provided (s1000). The sales staff 200 sells the beverage to the consumer 300 by using the chip-equipped vessel 210 provided.

When the consumer 300 requests to buy the beverage as a commodity at the sales store (s1001), the reader/writer device 220 recognizes whether the consumer 300 has brought a commodity vessel (s1002). This recognition processing may be performed by receiving input from the sales staff or detected by a sensor or the like. When it is recognized that the consumer has not brought any commodity vessel, a chip-equipped vessel 210 is provided to the consumer 300 (s1005). This providing process is performed by the reader/writer device 220 which issues an instruction to a mechanism providing the chip-equipped vessel 210 or outputs an instruction via an output section to the sales staff 200 to provide the chip-equipped vessel 210.

On the other hand, when it is recognized that the consumer has brought a commodity vessel, it is judged whether the vessel is a chip-equipped vessel 310 or a commodity vessel 311 having no non-contact IC chip (s1003). This processing can be performed by the read operation of the reader/writer section 240 of the reader/writer device 220 which detects presence/absence of the non-contact IC chip. Here, if it is judged that no non-contact IC chip is attached, a non-contact IC chip is attached to the commodity vessel brought by the consumer 300 (s1004).

Thus, the commodity vessel presented by the consumer 300 to the sales staff is a chip-equipped vessel 310. On the other hand, the reader/writer device 220 reads the non-contact IC chip 312 of the chip-equipped vessel 310 by using the reader/writer section 240 and acquires the storage information from the reader/writer section 240 (s1006).

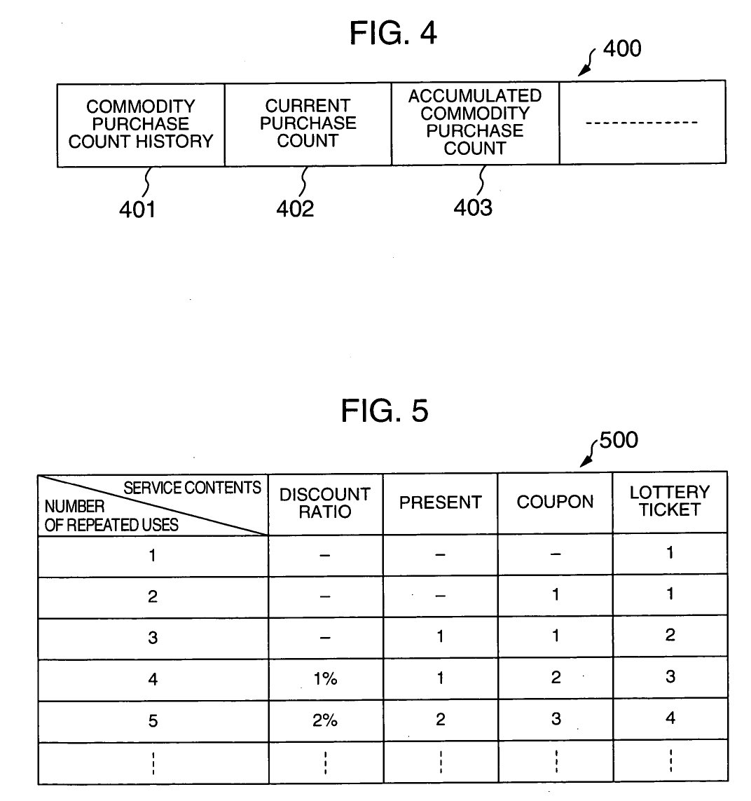

FIG. 4 shows an example of data structure recorded on the writable storage medium according to the present embodiment. The storage information acquired from the non-contact IC chip 312, for example, includes a commodity purchase count history (the number of purchases in the past) 401, a current purchase count (the number of purchases at the current sales) 402, and an accumulated number of commodity purchases (the latest number of purchases) 403.

Subsequently, the use history of the commodity vessel 311 is recognized from the acquired storage information. As the “number of uses of the vessel”, for example, there is a “commodity purchase count”. When it is assumed that the commodity is purchased by repeatedly using the same vessel, the “commodity purchase count” coincides with the “number of repeated uses of the vessel”. In addition to this, the number of times when the owner of the vessel changed may be used as the repeated use count. Moreover, the vessel use may be counted when the vessel is moved or when the vessel is subjected to a predetermined processing.

From the aforementioned example given with reference to FIG. 4, according to the commodity purchase count history information 401 and the current purchase count information 402, the number of repeated uses of the commodity vessel 311 up to now (accumulated commodity purchase count information 403) is recognized.

More specifically, the use count of the commodity vessel 311 counted upon commodity purchase at this time is written into the current purchase count information 402. The information 402 is added to the commodity purchase count history information 401 representing the number of repeated uses in the past so as to calculate information 403 on the accumulated commodity purchase count representing the latest commodity purchase count. After this, the accumulated commodity purchase count 403 is overwritten on the commodity purchase count history 401 so as to represent the number of repeated uses in the past.

The reader/writer device 220 compares the use history information recognized to a table 500 (FIG. 5) defining the service contents according to the number of repeated uses of the product and decides the service content. This table 500 is a data set including, for example, the number of repeated uses of the commodity vessel and corresponding discount ratio, present, coupon, lottery ticket, and the like arranged in a matrix and is stored in the memory 270 of the reader/writer device 220.

It should be noted that in the table 500 of FIG. 5, the service contents are decided according to the number of repeated uses of the commodity vessel but it is also possible to decide the service contents according to the “reuse frequency” representing the number of repeated uses in a month, for example.

According to the decided service content, for example, the purchase price is discounted or a present coupon is issued to provide a service to the consumer 300 (S1008). This processing result is output to the output section 260.

When the service providing is complete, the information on the reuse of the commodity vessel 311 accompanying the current commodity purchase is written into the non-contact IC chip 312 attached to the commodity vessel 311 via the reader/writer section 240 (s1009). Thus, a series of processes is complete. When this consumer 300 purchases the commodity next time, the processes of step s1001 and after are repeated by the reader/writer device 220.

The embodiment of the present invention has been thus far explained specifically. However, the present invention is not limited to this specific example but may be modified in various ways without departing the spirit and scope of the invention.

1. A method for providing appropriate services by a computer to a user of a repeated use of a product such as a commodity vessel or a commodity, said method comprising:
a step that the computer receives from a reader/writer section which has performed reading from a writable storage medium attached to the product presented by the product user, the storage information of the writable storage medium acquired by the reading operation,
a step of recognizing the use history of the product from the storage information acquired,
a step of judging the service content by checking the use history recognized in a table where service content is defined according to the number of repeated uses of the product, and
a step of executing a processing according to the service content judged and outputting the processing result to an output apparatus.

2. A method for providing services in recycling products according to claim 1, the method further comprising a step of instructing the reader/writer section to write a use history in the writable storage medium according to a commodity or a service when the presentation of the product by the product user is upon a commodity or service purchase accompanied by the repeated use of the product.

3. A method for providing services in recycling products according to claim 1, the method further comprising:
a step of attaching a writable storage medium to the product presented upon purchase of the commodity or service if the product has no writable storage medium, and
a step of instructing the reader/writer section to write the use history to the attached writable storage medium according to the commodity or service purchase content.

4. A method for providing services in recycling products according to claim 2, the method further comprising:
a step of attaching a writable storage medium to the product presented upon purchase of the commodity or service if the product has no writable storage medium, and
a step of instructing the reader/writer section to write the use history to the attached writable storage medium according to the commodity or service purchase content.

5. A method for providing services in recycling products according to claim 1, the method further comprising:
a step of providing a product having a writable storage medium if no product is presented by the product user upon purchase of the commodity or service, and
a step of instructing the reader/writer section to write the use history into the writable storage medium attached to the provided product according to the commodity or service purchase content.

6. A method for providing services in recycling products according to claim 2, the method further comprising:
a step of providing a product having a writable storage medium if no product is presented by the product user upon purchase of the commodity or service, and
a step of instructing the reader/writer section to write the use history into the writable storage medium attached to the provided product according to the commodity or service purchase content.

7. A computer for providing appropriate services to a user of a repeated use of a product such as a commodity vessel or a commodity, said computer comprising:
means for receiving from a reader/writer section which has performed reading from a writable storage medium attached to the product presented by the product user, the storage information of the writable storage medium acquired by the reading operation,
means for recognizing the use history of the product from the storage information acquired,
means for judging the service content by checking the use history recognized in a table where service content is defined according to the number of repeated uses of the product, and
means for executing a processing according to the service content judged and outputting the processing result to an output apparatus.

8. A program for causing a computer to execute a method for providing appropriate services to a user of a repeated use of a product such as a commodity vessel or a commodity, said program comprising:
a step of receiving from a reader/writer section which has performed reading from a writable storage medium attached to the product presented by the product user, the storage information of the writable storage medium acquired by the reading operation,
a step of recognizing the use history of the product from the storage information acquired,
a step of judging the service content by checking the use history recognized in a table where service content is defined according to the number of repeated uses of the product, and
a step of executing a processing according to the service content judged and outputting the processing result to an output apparatus.

9. A computer readable recording medium containing the service providing program according to claim 8.

10. A device for providing services to a user who is repeatedly using a vessel for containing a commodity to purchase the commodity, said device comprising:
a computer section,
a reader/writer section connected to the computer and capable of reading/writing information stored in a readable/writable storage medium, and
a memory section connected to the computer and capable of storing services to the user having different contents according to a number of repeated uses of the vessel,
wherein when the reader/writer section detects the readable/writable storage medium attached to the vessel, the computer section calculates a latest number of repeated uses of the vessel from the information in the readable/writable storage medium attached to the vessel, and
the computer section decides a service to be provided to the user corresponding to the latest number of repeated uses by referencing the memory section.

11. A device for providing services to a user according to claim 10, wherein the computer section reads a number of repeated uses of the vessel in the past from the information in the readable/writable storage medium attached to the vessel and overwrites the latest number of repeated uses on the number of repeated uses of the past in the readable/writable storage medium.

12. A device for providing services to a user according to claim 10, wherein the readable/writable storage medium is embedded in thickness of the vessel.

13. A device for providing services to a user according to claim 10, wherein the computer section executes processing to attach a readable/writable storage medium to the vessel when the reader/writer section does not detect a readable/writable storage medium attached to the vessel.
